(19) United States
(12) Patent Application Publication
(10) Pub. No.: US 2016/0114566 A1
(43) Pub. Date: Apr. 28, 2016

(54) SEALABLE POLYPROPYLENE FILM

(71) Applicant: TREOFAN GERMANY GMBH & CO. KG, Neunkirchen (DE)

(72) Inventors: Yvonne DÜPRE, Enkenbach-Alsenborn (DE); Detlef HÜTT, Heusweiler (DE)

(21) Appl. No.: 14/892,453

(22) PCT Filed: May 28, 2014
(86) PCT No.: PCT/EP2014/001437

§ 371 Date: Nov. 19, 2015

(30) Foreign Application Priority Data
Jun. 4, 2013 (DE) 10 2013 009 290.6

(51) Int. Cl. B32B 27/32; B65D 65/40; B32B 1/02; B32B 37/14; B32B 27/08; B32B 7/02

(52) U.S. Cl. CPC B32B 27/32; B32B 27/08; B32B 7/02; B32B 1/02; B32B 37/14; B65D 65/40; B32B 2255/10; B32B 2255/205; B32B 2307/536; B32B 2307/7246; B32B 2439/70

(57) ABSTRACT

The invention relates to a biaxially oriented, multilayer polypropylene film constituted of at least one base layer and one first intermediate layer I and a first sealable cover layer I applied to said intermediate layer I, the first intermediate layer I being a soft intermediate layer and all layers of the film substantially not containing vacuoles. The film is used for producing bag packaging.

The present invention relates to a sealable polypropylene film, a sealable metallised polypropylene film, and use thereof in laminates, and to a method for producing bag packaging from these laminates or from these films.

Biaxially oriented polypropylene (boPP) films are used nowadays as packaging films in a wide range of applications. Polypropylene films are characterised by many advantageous use properties, such as a high transparency, gloss, barrier against water vapour, good printability, rigidity, puncture resistance, etc. Besides the transparent films, opaque polypropylene films have been developed very successfully in recent years. On the one hand the special look (opacity and whiteness) of these films is particularly desirable for some applications. On the other hand opaque films offer the user a greater yield on account of the reduced density of these films. In some applications the vacuole-containing base layer contributes to a further improvement of desired film properties.

In spite of this variety of favourable properties, there are still now areas in which the polypropylene film must be combined with other materials in order to compensate for certain deficiencies. In particular for filling materials that are sensitive to moisture and oxygen, polypropylene films could not previously be asserted as the sole packaging material. By way of example, both the water vapour barrier and the oxygen barrier play a key role in the field of snack packaging. With a water uptake of only approximately 3%, potato chips and other snack items are so sticky that the consumer finds them inedible. In addition, the oxygen barrier must ensure that the fats contained in the snack items do not develop a rancid taste as a result of photo-oxidation. These requirements are not generally met by the polypropylene film alone as packaging material.

It is known to improve the barrier properties of boPP by a metallisation, whereby both the water vapour permeability and the oxygen permeability are significantly reduced. By way of example, the oxygen permeability of a transparent 20 μm boPP film can be reduced by metallisation and lamination with a further 20 μm transparent film to approximately 40 cm³/m²*day*bar. (see VR Interpack 99 Special D28 “Der gewisse Knack” [“The special snap”]).

In applications for particularly sensitive products, even the barrier of the metallised boPP films is insufficient. In such cases the lamination of a substrate with an aluminium film is preferred. This packaging is much more complex and costly than composites constituted of metallised boPP films, however it offers an excellent oxygen barrier on account of the lamination with the high-density aluminium film. By way of example, laminates of this type with aluminium film are used for what are known as packet soups and ready-made sauces (for example Maggi-Fix products) and similar powdery filling materials, which on account of the high fat content and the large surface of the powder have to be protected particularly effectively against light and oxygen.

An additional problem with a bag packaging for powders of this type is the contamination of the sealing area. In order to produce the bag packaging (four-edge sealing), three edges are first sealed and therefore an upwardly open bag is produced. The bag is then filled with the powder, wherein dusts of the powder also settle in the region of the fourth sealing seam. With the conventional methods for packing powders, this contamination of the sealing areas cannot be effectively prevented. These contaminations often lead to problems when sealing. The sealing seams in the contaminated areas have a reduced or even no strength, and the tightness of the sealing seam is likewise impaired.

Once the bags have been filled on the packaging machine, the sealing seams of the closed bags are additionally heavily loaded as a result of the fact that a number of filled bags are removed together from the conveyor belt by a gripper robot and are placed in a tightly packed manner in a cardboard box. The individual bags are held here merely by the lateral contact pressure of the gripper robot. The sealing seams must have a particularly high sealing seam strength in order to withstand this contact pressure.

These problems could be solved in the past only by lamination of the respective composites with a particular sealing film. Modern composite materials for powders of this type therefore comprise, in addition to the aluminium film, which ensures the barrier, a special sealing film that seals also when there is contamination and ensures an increased bursting pressure of the bag packaging, and also comprise further constituents where appropriate.

In some applications boPP films are also metallised only in view of the visual impression. Here, the consumer is to be given the impression of a high-quality packaging, without there actually being an improved barrier. In these cases the requirements on the metallised film are comparatively uncritical. The metallised film must have only a uniform look and a sufficient metal adhesion.

Document EP-A-1597073 describes a vacuole-containing, opaque, metallised polypropylene film having particular barrier properties. According to that teaching, opaque polypropylene films after metallisation may also have very good barrier values, when the metallised cover layer is constructed from a special propylene copolymer having a low ethylene content and a minimum thickness of 4 μm. On account of these good barrier values, these metallised opaque films can be used as constituent of a laminate for packet soups.

The object of the present invention was to provide a sealable film that is suitable for the production of bag packaging. The bag packaging must protect the filling material well against moisture and oxygen supply. The sealing seam of the bag packaging must have a good strength that can be attained also in the event of contamination in the region of the sealing seam. The bag packaging must withstand the overpressure of the packaging such that no pressure losses occur over time. The sealing seam must be mechanically stable with respect to the pressing force of the gripper robot, i.e. the packaging must not burst. All of these properties must then also be ensured when the seal region becomes polluted by the filling material, for example by powder, during the packing process.

The object of the present invention was thus to provide a metallised film having special sealing properties. In addition, the film must have excellent barrier properties after the metallisation, in particular with respect to oxygen and water vapour. The other routine use properties of the film in view of its use as laminate constituent are to be retained.

The application as bag packaging thus includes a complex requirements profile, i.e. the film must at the same time meet a series of requirements.

The object forming the basis of the invention is achieved by a biaxially oriented, multilayer polypropylene film having at least three layers, wherein the film comprises a base layer and a first intermediate layer I and a first sealable cover layer I applied to this intermediate layer I, the first intermediate layer I being a soft intermediate layer I and all layers of the film substantially not containing vacuoles.

The object is also achieved by a metallised, biaxially oriented polypropylene multilayer film that comprises a base layer and at least one first sealable cover layer I, wherein a soft first intermediate layer I is applied between the base layer and the first sealable cover layer I, and wherein all layers of the film substantially do not contain vacuoles, and wherein the film has a second cover layer II and is metallised on the outer surface of this second cover layer II.

The object is also achieved by a laminate that is produced from the metallised embodiment of the film according to the invention and a further film.

The object is also achieved by a bag packaging constituted of the laminates according to the invention or by a bag packaging that contains the film according to the invention.

The object is also achieved by a coffee packaging constituted of the laminates according to the invention.

The dependent claims specify preferred embodiments of the invention.

In the sense of the present invention the base layer is the layer of the film accounting for more than 50%, preferably more than 65%, of the total thickness of the film. Intermediate layers are layers that lie between the base layer and the respective cover layers. The first sealable cover layer I forms an outer layer of the coextruded film, which in the finished bag packaging forms the inner side of this bag. This first sealable cover layer I in accordance with the invention is in contact with the soft, first intermediate layer I. A second cover layer II can be applied directly to the base layer or to a second intermediate layer II. The surface of the second cover layer II is provided for metallisation (metallisation side of the film). In the case of a lamination of the film according to the invention with a further film, the lamination is performed against this metal layer.

Within the scope of the present invention it has been found that vacuole-containing films according to the prior art may have a good barrier after metallisation in spite of the vacuoles in the base layer, however the maximally attainable sealing seam strength of these films with vacuole-containing base layer is insufficient. In particular, bag packaging that is produced from these films bursts too frequently.

The present invention therefore proceeds from the known metallised transparent, i.e. vacuole-free, coextruded films, which in principle have acceptable to good barrier properties after metallisation. Various modifications of the coextruded sealing layer of these known films have been examined within the scope of the present invention in order to improve the sealing properties of these metallised films. The problem, however, could not be satisfactorily solved as a result.

It has surprisingly been found that the barrier properties and the sealing properties of the films according to the invention are improved when the transparent film has an additional, soft intermediate layer, which is connected to the first sealable cover layer I. On account of the soft intermediate layer, the quality of the sealing seam is impaired by powder contaminations to a much lesser extent. The resistance of the seal with respect to the internal pressure of the packaging is improved, whereby the internal pressure of the bag packaging can be considerably increased without the packaging bursting during the processing. In spite of the heavily increased internal pressure, there are no significant pressure losses, i.e. the pressure loss of a bag is heavily improved. Furthermore, as a result of these measures, the barrier properties of the metallised films according to the invention are improved compared with similarly structured films without a soft intermediate layer.

The metallised film according to the invention thus provides improved sealing properties compared with known transparent metallised films, in particular offers sealing seams having a particular mechanical strength and an improved barrier after metallisation both with respect to water vapour and with respect to oxygen. This film may therefore be used particularly advantageously for the production of bag packaging for water vapour- and oxygen-sensitive powdery filling materials. The bag packaging constituted of the film according to the invention is characterised further by low pressure losses and higher burst strength.

The film according to the invention is characterised inter alia in that it substantially does not contain vacuoles. All layers of the films according to the invention are therefore substantially vacuole-free, i.e. all layers of the film, in particular also the base layer, do not contain any vacuole-initiating fillers. Since the film does not contain any vacuoles, it does not present a reduced density compared with the components from which it is constructed. Vacuole-free therefore means in the sense of the present invention that the density of the film corresponds to the density of the starting materials and the respective proportion thereof in the film. Substantially vacuole-free means in particular that the density of the film is reduced by at most 5%, in particular by at most 2%, compared with the mathematical density. The mathematical density is the density that is calculated from the density of the components and proportion thereof in the film. Transparent embodiments of the film according to the invention thus have a density from 0.86 to 0.92 g/cm³, preferably from 0.88 to 0.92 g/cm³, in particular from 0.90-0.92 g/cm³, which corresponds substantially to the density of polypropylene (0.90-0.92 g/cm³).

### Base Layer

The base layer of the multilayer film according to the invention substantially contains polyolefin, preferably propylene polymers, and where appropriate further conventional additives, in each case in effective quantities, and also where appropriate pigments. Generally, the base layer contains at least 50% by weight, preferably 60 to 99% by weight, in particular 70 to 98% by weight polyolefins, in each case in relation to the weight of the base layer.

Polyolefins of the base layer are generally non-soft polymers, wherein the characteristics of soft polymers will be explained in greater detail in conjunction with the intermediate layer I. Propylene polymers are preferred as polyolefins of the base layer. These propylene polymers contain 90 to 100% by weight, preferably 95 to 100% by weight, in particular 98 to 100% by weight propylene units and have a melting point of 120° C. or above, preferably 150 to 170° C., and generally a melt flow index from 1 to 10 g/10 min, preferably 2 to 8 g/10 min, at 230° C. and a force of 21.6 N (DIN 53735). Isotactic propylene homopolymer with an atactic proportion of 15% and less, copolymers of ethylene and propylene with an ethylene content of 5% by weight or less, copolymers of propylene with C₄-C₈ olefins with a C₄-C₈ olefin content of 5% by weight or less, terpolymers of propylene, ethylene and butylene with an ethylene content of 10% by weight or less and with a butylene content of 15% by weight or less constitute preferred propylene polymers for the base layer, wherein isotactic propylene homopolymer is particularly preferred. The specified percentages by weight relate to the respective polymers.

Furthermore, a mixture of the specified propylene homopolymers and/or copolymers and/or terpolymers and other polyolefins, in particular constituted of monomers having 2 to 6 C atoms, is suitable, wherein the mixture contains at least 50% by weight, in particular at least 75% by weight, propylene polymer.

In a further embodiment the base layer may additionally contain opacifying, i.e. opaque-making, pigments, wherein the polymer proportion is reduced accordingly. These embodiments have a white, obscure appearance, i.e. they are opaque, but vacuole-free, since pigments initiate substantially no vacuoles. Pigments are added in a quantity of at most 25% by weight, preferably 0.5 to 15% by weight, in particular 2 to 10% by weight, in relation to the weight of the base layer. It is essential to the invention that the pigments initiate substantially no vacuoles, since the film must be vacuole-free on the whole. In the sense of the present invention “opaque” means a light permeability of the film of (ASTM-D 1003-77) at most 70%, preferably at most 50%.

Pigments in the sense of the present invention are incompatible particles that substantially do not lead to vacuole formation as the film is stretched. The colouring effect of the pigments is caused by the particles themselves. So that the pigments do not generate any vacuoles, they must have a mean particle diameter in the range from 0.01 to at most 1 μm. The term “pigments” includes both what are known as “white pigments”, which colour the films white, although “coloured pigments” also appear to be possible where appropriate, which provide the film with a bright or black colour. Generally, the mean particle diameter of the pigments lies in the range from 0.01 to 1 μm, preferably 0.01 to 0.7 μm, in particular 0.01 to 0.4 μm.

Conventional pigments are materials such as aluminium oxide, aluminium sulphate, barium sulphate, calcium carbonate, magnesium carbonate, silicates such as aluminium silicate (kaolin clay) and magnesium silicate (talcum), silicon dioxide and titanium dioxide, of which white pigments such as calcium carbonate, silicon dioxide, titanium dioxide and barium sulphate are preferably used. Titanium dioxide is particularly preferred. Various modifications and coatings of TiO₂ are known per se in the prior art.

For opaque embodiments with pigments, such as TiO₂, for example in the base layer and/or the first intermediate layer I, the density of the film is increased compared with the density of polypropylene by the addition of TiO₂. For these embodiments of the film according to the invention, the density preferably lies in a range from 0.91 to 0.95 g/cm³, in particular 0.92 to 0.94 g/cm³. This density of the opaque embodiment of the film is substantially not reduced compared with the mathematical density, i.e. the specified density likewise lies at most 5%, preferably at most 2%, below the mathematical density, which is calculated from the density of the components and proportion thereof in the film.

### Soft Intermediate Layer I

The multilayer film according to the invention comprises at least one first soft intermediate layer I applied between the base layer and the sealable cover layer I. In accordance with the invention, this soft intermediate layer I is constructed from polyolefins that are softer than the polyolefins of the base layer. Various criteria may be used for the selection of a soft polyolefin, for example the melting point Tm, the softening point, the features of the second heating curve of a DSC measurement and/or the breadth of the melting range or the crystallinity or also the Shore hardness of the polyolefins. The soft intermediate layer I can be constructed from one or more soft polymers. The soft polymers are preferably also mixed with other non-soft polymers, i.e. with polymers that do not satisfy the above-described criteria for the soft polymers. Mixtures of this type containing a plurality of soft and non-soft polyolefins will be referred to hereinafter collectively as “mixtures”.

Soft polyolefins differ from “non-soft” polyolefins by their melting behaviour. Soft polyolefins start to soften already at relatively low temperatures, such that the melting process is more of a continuous process that takes place over a very broad temperature range. Soft polyolefins in a DSC measurement present a second heating curve that rises continuously already from 20 to 70° C. (A), reaches a first local maximum (softening point B) at a temperature of >90° C., and then transitions into the actual maximum of the heating curve (C), i.e. the melting point Tm. When all components of the soft polyolefin or of the mixture have melted, the heating curve drops again to the base line (D). The melting range of the soft polyolefin or of the mixture is the range between the softening point (B) and the melting point (C) and de facto the temperature range in which the actual melting process takes place.

By contrast, non-soft polyolefins present a second heating curve, which starts to rise only at a temperature from 110 to 140° C. (X) and then generally leads into a maximum Y (melting point Tm) via a sharp rise. Here as well the heating curve then drops to the base line (Z) when all components have melted. A separate softening point is generally not discernible in the DSC curve of the non-soft polyolefins or is superimposed by the melt peak such that no separate first maximum occurs or is discernible. The heating curves of the non-soft polyolefins therefore de facto do not have their own softening point and do not have a melting range in the sense of the above definition.

The parameters “melting point”, “softening point” and “melting range” are determined by means of DSC measurement and are determined from the second heating curve of the DSC measurement of the soft polymer or the mixture, wherein heating and cooling are performed at a heating and cooling rate of 10 K/min.

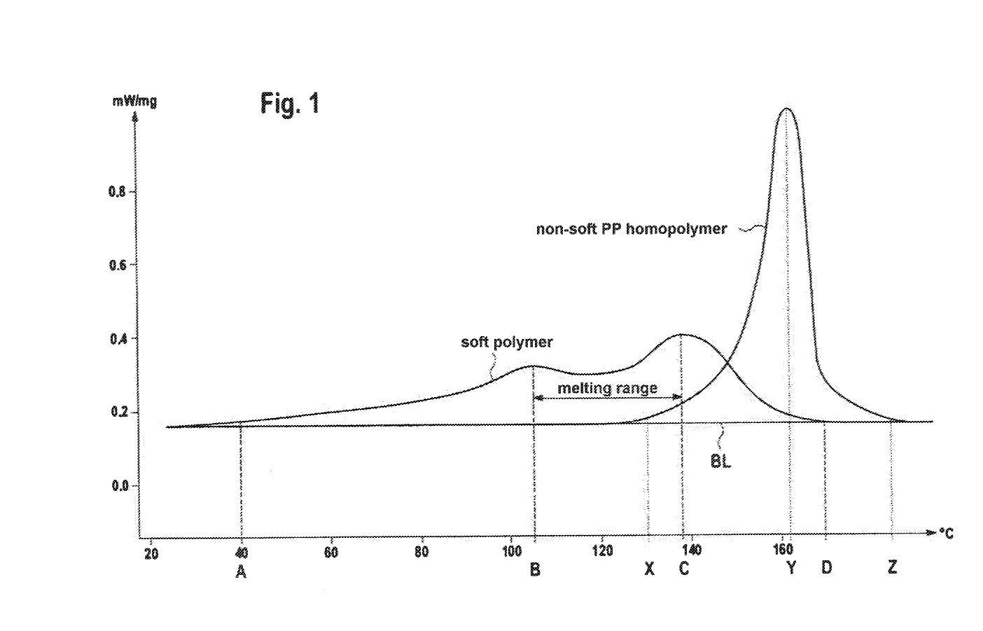

FIG. 1 schematically illustrates the second heating curve of a soft polyolefin or of a mixture and the second heating curve of a non-soft isotactic propylene homopolymer in comparison. In this schematic example the rise of the heating curve of the soft polymer starts at a temperature of approximately 40° C. (A). The DSC curve then presents a continuous rise, i.e. an increasingly greater distance from the base line (BL). The softening point (B) is clearly discernible as first maximum at approximately 105° C. before the second maximum at approximately 135° C. (melting point (C)). The heating curve then falls at approximately 161° C. to the base line, since the polyolefin is then completely melted and the melting process is complete (D). In this schematic example the breadth of the melting range is therefore approximately 30° C.

By contrast, the rise of the heating curve in the case of the non-soft polymer starts at much higher temperatures, here for example at approximately 130° C. The melting process then starts relatively quickly, the DSC curve rises sharply, and leads directly into the melting point at 162° C. (Y). At 168° C. (Z) the melting process is complete. The heating curve drops to the base line. The predominantly crystalline propylene homopolymer does not present any discernible, separate softening point in the DSC curve. A melting range in the sense of the above definition therefore cannot be derived from the second heating curve of the DSC measurement. De facto, the melting process takes place in a much narrower temperature range between the sharp rise and the sharp drop of the melt peak, here approximately 155-162° C., corresponding to a range of 7° C.

The soft polyolefin or the mixture of the intermediate layer I generally has a melting point Tm (point C in FIG. 1) in the range of at most 150° C., preferably 70 to 140° C., in particular 80 to 130° C.

The soft polyolefin or the mixture of the intermediate layer generally has a lower melting point Tm than the polyolefin of the base layer. The melting points Tm of the base and of the intermediate layer I should advantageously differ by at least 10° C. The melting point Tm of the soft polyolefin or the mixture of the intermediate layer I is preferably 15 to 60° C., in particular 30 to 50° C. less than the melting point Tm of the polyolefin of the base layer.

Alternatively or additionally, the softening point can also be used. Soft polyolefins present a softening point in the DSC curve. This softening point of the soft polyolefin or the mixture (point B in FIG. 1) lies generally in a range from 80 to 120° C., preferably 90 to 110° C., whereas the polyolefin of the base layer does not have a separate softening point in the second heating curve.

In addition, it is advantageous for the polyolefin or the mixture of the intermediate layer I to have a broad melting range (B-C). This means that a separate softening point (B) is clearly discernible in the second heating curve of the soft polyolefin or the mixture, i.e. is different from the melting point of the soft polymer, and this softening point and the melting point of the soft polyolefin or of the mixture lie preferably at least 60 K, preferably 10 to 50 K, from one another.

Soft polyolefins or mixtures in the sense of the present invention are also or alternatively characterised in that the heating curve thereof starts to rise in a range from 20 to 70° C., preferably 25 to 60° C., whereas the similar rise in the case of the non-soft polyolefins starts only in a range from 110 to 140° C.

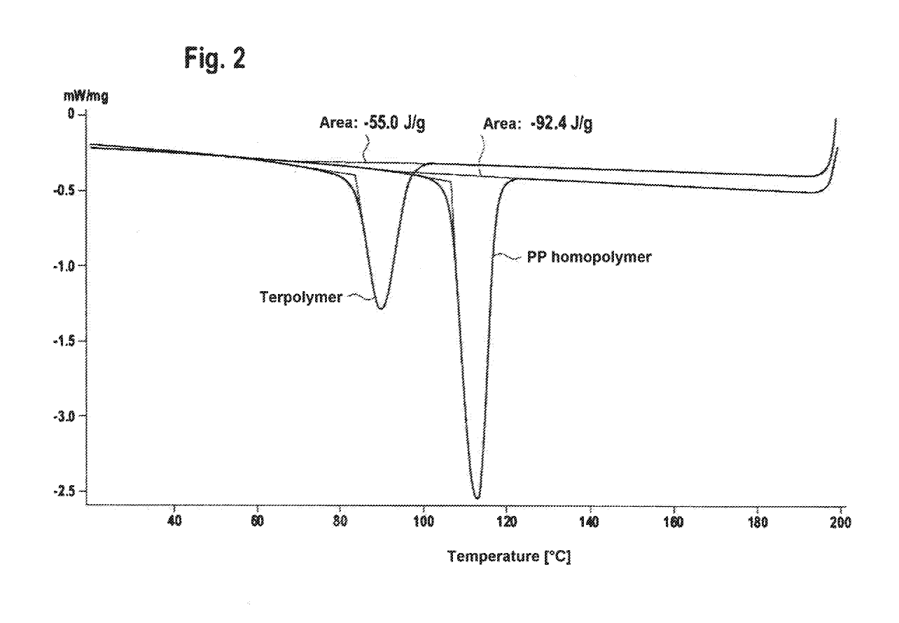

The melt enthalpy can be used as a further selection criterion for soft polymers. The enthalpy of the soft polymers is lower than the enthalpy of the polymers of the base layer. The enthalpy is determined from the cooling curve of the DSC measurement as area below the crystallisation peak. The enthalpy of the soft polymers lies generally in a range from 40 to 65 J/g, preferably 50 to 60 J/g. The typical cooling curve of a soft and of a non-soft polymer is illustrated in FIG. 2.

The first intermediate layer I generally contains at least 40% by weight, preferably 60 to 100% by weight, in particular 75 to 99% by weight of a soft polyolefin, in each case in relation to the weight of the intermediate layer I, wherein different soft polyolefins can also be mixed with one another where appropriate. Additives can be added to the intermediate layer I where appropriate, in each case in effective quantities. Furthermore, additional polymers may be contained that do not meet the criteria for a soft polyolefin. The proportion thereof should be selected such that the mixture of soft polymers and non-soft polymers corresponds to the above-described requirements for the soft polyolefins, i.e. the above-described requirements in respect of melting point, softening point, melting range, features of the second heating curve, and enthalpy are then to be satisfied by the polymer mixture.

Soft polyolefins that meet the above-described criteria are for example polyolefins constituted of olefins having 2 to 10 C atoms, of which the polymers specified below constituted of ethylene, propylene and butylene units are preferred. Soft polyolefins are preferably polyethylenes, propylene copolymers and/or propylene terpolymers, and also the propylene homopolymers with low crystallinity.

Suitable propylene copolymers or terpolymers are generally constructed from at least 50% by weight propylene and ethylene and/or butylene units as comonomer. Preferred mixed polymers are statistical ethylene-propylene copolymers with an ethylene content from 2 to 10% by weight, preferably 5 to 8% by weight, or statistical propylene-butylene-1 copolymers with a butylene content from 4 to 25% by weight, preferably 10 to 20% by weight, in each case in relation to the total weight of the copolymer, or statistical ethylene-propylene-butylene-1 terpolymers with an ethylene content from 1 to 10% by weight, preferably 2 to 6% by weight, and a butylene-1 content from 3 to 20% by weight, preferably 8 to 10% by weight, in each case in relation to the total weight of the terpolymer. These co- and terpolymers generally have a melt flow index from 3 to 15 g/10 min, preferably 3 to 9 g/10 min (230° C., 21.6 N DIN 53735) and a melting point from 70 to 145° C., preferably 90 to 140° C. (DSC).

Suitable soft propylene homopolymers preferably have an isotacticity of less than 95% and a xylene-soluble proportion of at least 3 to 10% by weight, preferably 4 to 7% by weight. Propylene homopolymers contain 98 to 100% by weight, preferably 99 to 100% by weight propylene units and have a melting point from 150 to 162° C., preferably 155 to 160° C., and generally a melt flow index from 1 to 10 g/10 min, preferably 2 to 8 g/10 min, at 230° C. and a force of 21.6 N (DIN 53735).

Suitable polyethylenes are for example HDPE, MDPE, LDPE, LLDPE and VLDPE, of which HDPE and MDPE types are particularly preferred. HDPE generally has an MFI (50 N/190° C.) of greater than 0.1 to 50 g/10 min, preferably 0.6 to 20 g/10 min, measured in accordance with DIN 53 735 and a viscosity number, measured in accordance with DIN 53 728, Part 4, or ISO 1191, in the range from 100 to 450 cm³/g, preferably 120 to 280 cm³/g. The crystallinity is 35 to 80%, preferably 50 to 80%. The density, measured at 23° C. in accordance with DIN 53 479, method A, or ISO 1183, lies in the range from >0.94 to 0.96 g/cm³. The melting point, measured with DSC (maximum of the melt curve, heating rate 20° C./min), lies between 120 and 140° C. Suitable MDPE generally has an MFI (50 N/190° C.) of more than 0.1 to 50 g/10 min, preferably 0.6 to 20 g/10 min, measured in accordance with DIN 53 735. The density, measured at 23° C. in accordance with DIN 53 479, method A, or ISO 1183, lies in the range from >0.925 to 0.94 g/cm³. The melting point, measured with DSC (maximum of the melt curve, heating rate 20° C./min), lies between 115 and 130° C.

In a further embodiment polymers having very low crystallinity or predominantly amorphous character can be used as soft polymers for the intermediate layer I, for example elastomers or heterophase mixed polymers. Polymers of this type are obtainable for example under the trade names Adflex (Basell), Koattro (Basell) or Vistamaxx (ExxonMobil).

### Sealable Cover Layer I

In accordance with the invention a sealable first cover layer I is applied to the above-described soft intermediate layer I. The sealable cover layer I generally contains at least 80% by weight, preferably 90 to <100% by weight sealable olefinic polymers or mixtures thereof. Suitable polyolefins by way of example are polyethylenes, propylene copolymers and/or propylene terpolymers.

Propylene co- or terpolymers are generally constructed from at least 50% by weight propylene and ethylene and/or butylene units as comonomer. Preferred mixed polymers are statistical ethylene-propylene copolymers with an ethylene content from 2 to 10% by weight, preferably 5 to 8% by weight, or statistical propylene-butylene-1 copolymers with a butylene content from 4 to 30% by weight, preferably 10 to 25% by weight, in each case in relation to the total weight of the copolymer, or statistical ethylene-propylene-butylene-1 terpolymers with an ethylene content from 1 to 10% by weight, preferably 2 to 6% by weight, and a butylene-1 content from 3 to 20% by weight, preferably 8 to 10% by weight, in each case in relation to the total weight of the terpolymer. These co- and terpolymers generally have a melt flow index from 3 to 15 g/10 min, preferably 3 to 9 g/10 min (230° C., 21.6 N DIN 53735) and a melting point from 70 to 145° C., preferably 90 to 140° C. (DSC).

In view of the use of the film as bag packaging for powdery filling materials, a mixture constituted of the described propylene copolymers and/or propylene terpolymers is preferred for the sealable cover layer I. These cover layer mixtures are particularly advantageous in view of the sealing properties of the film. Surprisingly, the contaminations when sealing are not disruptive or are only slightly disruptive when the sealing layer I is constructed from a mixture of the described propylene copolymers and/or propylene terpolymers.

In a particularly preferred embodiment the cover layer I has a seal initiation temperature SIT of less than 110° C., preferably 75 to 105° C., in particular from 80 to 100° C. It has surprisingly been found that the low SIT in conjunction with the soft intermediate layer I and the vacuole-free structure of the film has a positive effect in the “bag packaging” application. The sealing is only insignificantly impaired by the contaminations, and the bursting strength and the mechanical load-bearing capability of the sealing seam are considerably improved when all three features in combination with one another are satisfied in a film. In particular, the film according to the invention and the bag packaging constituted of the film according to the invention present a much better strength of the sealing seam. Low seal initiation temperatures in the case of packaging films are normally desirable when quick processing speeds are implemented in the production of packaging from the films, for example in the case of HFFS and VFFS wrapping machines. Since the packaging speeds, however, in the production of bag packaging are generally much slower than for example on HFFS machines, there would be no suggestion for a person skilled in the art to design the sealing layer I such that the film has a low SIT. In addition, the effect of the low seal initiation temperature in conjunction with the soft intermediate layer I and the vacuole-free structure of the film on the mechanical load-bearing capability of the sealing seam was not foreseeable. In particular, it was not possible to anticipate the positive effects on the bag packaging caused by the combination of the above features.

Propylene copolymers and propylene terpolymers that are particularly suitable for these embodiments with low SIT are for example C₃C₄ copolymers with a butylene content from 10 to 30% by weight, preferably 12 to 28% by weight, or C₂C₃C₄ terpolymers with an ethylene content from 1 to 10% by weight, preferably 2 to 6% by weight, and a butylene-1 content from 3 to 20% by weight, preferably 8 to 10% by weight, in each case in relation to the total weight of the terpolymer or mixtures thereof. These polymers are for example obtainable under the trade names Mitsui Tafmer XM 7080, Mitsui Tafmer XM 7070, and ExxonMobil Vistamaxx 3980 FL.

The sealable cover layer I preferably is not pre-treated by means of corona or flame or plasma. It has been found that an untreated surface of the sealing layer I positively influences the properties of the bag packaging, in particular pressure losses of the bag packaging with an untreated sealing layer I are less than with a bag packaging having a sealing layer treated by corona or in another way.

In a further embodiment the sealing layer I may additionally contain polyethylenes, generally in an amount from 10 to 40% by weight, preferably from 15 to 35% by weight, in each case in relation to the sealing layer I. Suitable polyethylenes are for example HDPE, MDPE, LDPE, LLDPE and VLDPE, of which HDPE and MDPE types are particularly preferred. HDPE generally has an MR (50 N/190° C.) of greater than 0.1 to 50 g/10 min, preferably 0.6 to 20 g/10 min, measured in accordance with DIN 53 735, and a viscosity number, measured in accordance with DIN 53 728, Part 4, or ISO 1191, in the range from 100 to 450 cm³/g, preferably 120 to 280 cm³/g. The crystallinity is 35 to 80%, preferably 50 to 80%. The density, measured at 23° C. in accordance with DIN 53 479, method A, or ISO 1183, lies in the range from >0.94 to 0.96 g/cm³. The melting point, measured with DSC (maximum of the melt curve, heating rate 20° C./min), lies between 120 and 140° C. Suitable MDPE generally has an MFI (50 N/190° C.) of more than 0.1 to 50 g/10 min, preferably 0.6 to 20 g/10 min, measured in accordance with DIN 53 735. The density, measured at 23° C. in accordance with DIN 53 479, method A, or ISO 1183, lies in the range from >0.925 to 0.94 g/cm³. The melting point, measured with DSC (maximum of the melt curve, heating rate 20° C./min), lies between 115 and 130° C.

### Second Cover Layer II/Metallised Cover Layer

The film on the side opposite the soft intermediate layer I/sealable cover layer I has a further second cover layer II, which is provided for the metallisation. This cover layer II can be applied directly to the transparent or pigmented base layer, or the film has a second intermediate layer II between the second cover layer II and the base layer.

The second cover layer II generally contains at least 80% by weight, preferably 90 to <100% by weight olefinic polymers or mixtures thereof. Suitable polyolefins are for example propylene copolymers and/or propylene terpolymers, and also the propylene homopolymers already described in conjunction with the base layer.

Suitable propylene copolymers or terpolymers are generally constructed from at least 50% by weight propylene and ethylene and/or butylene units as comonomer. Preferred mixed polymers are statistical ethylene-propylene copolymers with an ethylene content from 2 to 10% by weight, preferably 5 to 8% by weight, or statistical propylene-butylene-1 copolymers with a butylene content from 4 to 25% by weight, preferably 10 to 20% by weight, in each case in relation to the total weight of the copolymer, or statistical ethylene-propylene-butylene-1 terpolymers with an ethylene content from 1 to 10% by weight, preferably 2 to 6% by weight, and a butylene-1 content from 3 to 20% by weight, preferably 8 to 10% by weight, in each case in relation to the total weight of the terpolymer. These co- and terpolymers generally have a melt flow index from 3 to 15 g/10 min, preferably 3 to 9 g/10 min (230° C., 21.6 N DIN 53735) and a melting point from 70 to 145° C., preferably 90 to 140° C. (DSC).

Furthermore, propylene polymers having a low ethylene content and a high melting point can be used for the second cover layer II. These polymers are known per se as mini copolymers. For these embodiments, propylene-ethylene copolymers having an ethylene content from 0.5 to 3.0% by weight, in particular 0.8 to 2.5% by weight, preferably 1.0 to <2% by weight, are particularly preferred. The melting point thereof lies preferably in a range from 150 to 155° C., and the melt enthalpy lies preferably in a range from 90 to 100 J/g. The melt flow index is generally 3 to 15 g/10 min, preferably 3 to 9 g/10 min (230° C., 21.6N DIN 53 735).

In order to improve the metal adhesion, the surface of the second cover layer II is generally subjected by means of corona, flame or plasma to a method for increasing the surface tension, in a manner known per se. The surface tension of the as yet non-metallised cover layer II treated in this way then typically lies in a range from 35 to 45 mN/m. Alternatively or additionally, the surface of the cover layer II can be subjected directly before the metallisation to a plasma treatment in order to further improve the barrier properties of the metallised film and the metal adhesion.

Besides this primary constituent, the second cover layer II may contain additional additives, such as anti-blocking agents, stabilisers and/or neutralisation agents, in each case in effective quantities. In view of the metallisation, additives that impair the metallisability should not be contained in the cover layer II. This applies for example for migrating lubricants or antistatic agents.

### Second Intermediate Layer II

In a further embodiment according to the invention the film has a second intermediate layer II, which is applied between the metallisable, second cover layer II and the base layer.

This second intermediate layer II may be constructed in principle from the polymers described for the second cover layer II, wherein the specified propylene homopolymers or the described mini copolymers are preferred. The second intermediate layer II generally contains at least 80% by weight, preferably 95 to 100% by weight, in particular 98 to <100% by weight propylene polymers, wherein the composition of the second cover layer II and of the second intermediate layer II generally is not identical.

The embodiments with a combination of second intermediate layer II and second cover layer II are advantageous in view of possible different additives of the individual layers. By way of example, it is thus possible to add anti-blocking agents only to the cover layer II and to keep the intermediate layer II free from other additive materials. However, both layers generally contain stabilisers and neutralisation agents. In particular, substantially no vacuole-containing fillers are contained in the second intermediate layers II either. TiO₂ can be added without significant technical disadvantages, wherein the quantity in view of a smooth, metallisable surface should be less than 10% by weight, in relation to the intermediate layer II.

The overall thickness of the film may vary within wide limits, preferred embodiments have an overall thickness from 10 to 150 μm, preferably from 12 to 100 μm, in particular 15 to 50 μm. The base layer in the sense of the present invention is the layer accounting for more than 50% of the overall thickness of the film. Its thickness is given from the difference of overall thickness and the thickness of the applied cover and intermediate layers.

The film according to the invention generally has at least four layers and as essential layers always comprises the base layer (BS) and a first sealable cover layer I (DSI I), a first intermediate layer I (ZWSI) and a second metallisable cover layer II (DSII) in accordance with a structure DSI ZWSI/BS/DSII. The film comprises a second intermediate layer II ZWSII where appropriate, in accordance with a structure DSI/ZWSI/BS/ZWSII/DSII. Depending on the field of use, the film may also comprise further layers.

The thickness of the first sealable cover layer I is generally 0.5 to 5 μm, preferably 0.5 to 3 μm, in particular 0.8 to 2.5 μm.

The thickness of the first intermediate layer I is generally 1.0 to 12 μm, preferably 1.5 to 10 μm, in particular 2.0 to 7.0 μm.

The thickness of the second metallisable cover layer II is generally 0.5 to 5 μm, preferably 0.5 to 3 μm, in particular 0.8 to 2.5 μm.

The thickness of the second intermediate layer II is generally 0.5 to 10 μm, preferably 0.8 to 8 μm, in particular 1.0 to 5.0 μm.

In order to improve certain properties of the polypropylene film according to the invention further still, both the base layer and the intermediate layer(s) and/or the cover layer(s) may contain additives, in each case in an effective quantity, preferably antistatic agents and/or anti-blocking agents and/or lubricants and and/or stabilisers and/or neutralisation agents compatible with the polymers of the layers, with the exception of the anti-blocking agents, which generally are incompatible. All specified quantities in the following description in percentage by weight (% by weight) relate to the respective layer to which the additive may be added.

All layers of the film generally preferably contain neutralisation agents and stabilisers, in each case in effective quantities.

The conventional compounds acting in a stabilising manner can be used as stabilisers for ethylene, propylene and other olefin polymers. The added quantity thereof lies between 0.05 and 2% by weight. Phenolic stabilisers, alkali/earth alkali stearates and/or alkali/earth alkali carbonates are particularly suitable. Phenolic stabilisers in a quantity from 0.1 to 0.6% by weight, in particular 0.15 to 0.3% by weight and with a molar mass of more than 500 g/mol are preferred. Pentaerythrityl-tetrakis-3-(3,5-di-tertiary butyl-4-hydroxyphenyl)-propionate or 1,3,5-trimethyl-2,4,6-tris(3,5-di-tertiary butyl-4-hydroxybenzyl)benzene are particularly advantageous.

Neutralisation agents are preferably calcium stearate and/or calcium carbonate and/or synthetic dihydrotalcite (SHYT) with a mean particle size of most 0.7 μm, an absolute particle size of less than 10 μm, and a specific surface of at least 40 m²/g. Neutralisation agents are generally used in an amount from 50 to 1000 ppm, in relation to the layer.

Anti-blocking agents are added to the cover layer I to be metallised and/or to the sealable cover layer II, wherein embodiments with anti-blocking agents in both cover layers are preferred. Suitable anti-blocking agents are inorganic additives, such as silicon dioxide, calcium carbonate, magnesium silicate, aluminium silicate, calcium phosphate and the like, and/or incompatible organic polymers, such as polyamides, polyesters, polycarbonate and the like, or cross-linked polymers, such as cross-linked polymethyl methacrylate or cross-linked silicone oils. Polymethyl methacrylate, silicon dioxide and calcium carbonate are preferred. The mean particle size lies between 1 and 6 μm, in particular 2 and 5 μm. The effective quantity of anti-blocking agent lies in the range from 0.1 to 5% by weight, preferably 0.5 to 3% by weight, in particular 0.8 to 2% by weight.

Lubricants are preferably added to the base layer of the first intermediate layer I and/or to the first cover layer I. Lubricants are higher aliphatic acid amides, higher aliphatic acid esters and metal soaps, and also polydimethyl siloxanes. The effective quantity of lubricant lies in the range from 0.01 to 3% by weight, preferably 0.02 to 1% by weight, in relation to the respective cover layer. The addition of 0.01 to 0.3% by weight of aliphatic acid amides, such as erucic acid amide or 0.02 to 0.5% by weight of polydimethyl siloxanes, in particular polydimethyl siloxanes with a viscosity from 5 000 to 1 000 000 mm²/s, is particularly suitable.

Antistatic agents are added where appropriate to the base layer, the first intermediate layer I and/or the first cover layer I. Preferred antistatic agents are glycerol monostearates, alkali alkane sulfonates, polyether-modified, i.e. ethoxylated and/or propoxylated polydiorganosiloxanes (polydialkyl siloxanes, polyalkyl phenyl siloxanes and the like), and/or the substantially straight-chain and saturated aliphatic, tertiary amines having an aliphatic group containing 10 to 20 carbon atoms substituted with alpha-hydroxy-(C1-C4) alkyl groups, wherein N,N-bis-(2-hydroxyethyl) alkyl amines containing 10 to 20 carbon atoms, preferably 12 to 18 carbon atoms, in the alkyl group are particularly preferred. The effective quantity of antistatic agent lies in the range from 0.05 to 0.5% by weight.

All of the above specifications in % by weight relate to the weight of the respective layer in which the additive is contained.

The invention also relates to a method for producing the multilayer films according to the invention by the coextrusion method, which is known per se, wherein in particular the stenter method is preferred.

Within the scope of this method the melts corresponding to the individual layers of the film are coextruded through a flat film die, the film thus obtained is drawn off for solidification on one or more roll(s), the film is then stretched (oriented), and the stretched film is then heat set and optionally plasma-, corona- or flame-treated at the surface layer intended for treatment.

More specifically, as in the extrusion method, the polymers or the polymer mixture of the individual layers is/are compressed here in an extruder and liquefied, wherein optionally added additives may already be contained in the polymer or in the polymer mixture. Alternatively, these additives can also be incorporated via a master batch.

The melts are then optionally pressed jointly and simultaneously through a flat film die (slit die), and the pressed multilayer film is drawn off on one or more take-off rolls at a temperature from 5 to 100° C., preferably 10 to 50° C., wherein said film cools and solidifies.

The film thus obtained is then stretched longitudinally and transversely to the extrusion direction, which leads to an orientation of the molecule chains. The longitudinal stretching is preferably performed at a temperature from 80 to 150° C., expediently with the aid of two rolls running at different speeds in accordance with the sought draw ratio, and the transverse stretching is preferably performed at a temperature from 120 to 170° C. with the aid of an appropriate clip frame. The longitudinal draw ratios lie in the range from 4 to 8, preferably 4.5 to 6. The transverse draw ratios lie in the range from 5 to 10, preferably 7 to 9.

The stretching of the film is followed by the heat setting of said film (heat treatment), wherein the film is held for approximately 0.1 to 10 s long at a temperature from 100 to 160° C. The film is then usually rolled up using a winding device. These methods are known per se in the prior art and have been described many times in film patents.

Following the biaxial stretching, one or both surface/s of the film is/are preferably plasma-, corona- or flame-treated in accordance with one of the known methods. The treatment intensity generally lies in the range from 35 to 45 mN/m, preferably 37 to 45 mN/m, in particular 38 to 41 mN/m.

For the alternative corona treatment the film is passed through between two conductor elements serving as electrodes, wherein a sufficiently high voltage, usually an AC voltage (approximately 10,000 V and 10,000 Hz), is applied between the electrodes so that spray or corona discharges can take place. Due to the spray or corona discharge, the air above the film surface is ionised and reacts with the molecules of the film surface, such that polar deposits in the essentially unipolar polymer matrix are produced. The treatment intensities lie within the conventional scope, wherein 37 to 45 mN/m are preferred.

The coextruded multilayer film is then provided on the outer surface of the second cover layer II with a metal layer, preferably made of aluminium, in accordance with the methods known per se. This metallisation is performed in a vacuum chamber in which aluminium for example is evaporated and precipitated on the film surface. In a preferred embodiment the surface to be metallised of the cover layer II is subjected directly before the metallisation to a plasma treatment. The thickness of the metal layer generally correlates with the optical density of the metallised film, i.e. the thicker is the metal layer, the higher is the optical density of the metallised film. The optical density of the metallised film according to the invention should generally be at least 2, in particular 2.5 to 4. The film thus metallised can be used directly for the production of bag packaging, for example for packaging of mash potato flakes, ground coffee, etc.

The film according to the invention is characterised after the metallisation by excellent barrier values. The water vapour permeability of the metallised film according to the invention is generally <0.5 g/m²*day at 38° C. and 90% relative air humidity, preferably in a range from 0.005 to 0.3 g/m²*day. The oxygen permeability is preferably <50 cm³/m²*day*bar, preferably 5 to 30 cm³/m²*day*bar, in particular 5 to 25 cm³/m²*day*bar.

In a preferred embodiment the metallised film according to the invention is laminated with a further, preferably biaxially oriented film, wherein the lamination is performed against the metallised side of the metallised film according to the invention. The further film is preferably printed so that the bag packaging has an attractive look. In principle, polyester films, boPP films (transparent or also opaque boPP films) can be used for the further film. The lamination of the metallised film against paper is also possible. The metallised film according to the invention is preferably laminated against an opaque multilayer boPP film having a vacuole-containing base layer and a printable cover layer. By way of example, four-layer films with a cover layer on a surface of the base layer suitable for the lamination against the metal layer and with a combination of homopolymer intermediate layer modified with TiO₂ where appropriate and printable cover layer applied thereto on the opposite surface of the base layer are suitable. These laminates are characterised by a particularly appealing surface gloss of the finished printed laminate and can be used advantageously for the production of bag packaging.

The film according to the invention is characterised by extraordinary sealing properties, in particular in that the attained sealing seam strengths are unusually high. In the case of a sealing of the first cover layer against itself at 130° C., 10 N/cm² and 0.5 s, the maximum sealing seam strength is at least 6 N/15 mm, preferably 6.5 to 10 N/15 mm.

Bag packaging that comprises the film according to the invention presents an excellent bursting pressure. If it is managed to produce the bag packaging without significant contamination of the sealing seam, the bag packaging presents a bursting pressure in the range from 300 to 1000 mbar, preferably 350 to 900 mbar, in particular 400 to 800 mbar. If the sealing seam is polluted by dusts, the bag packaging still has a bursting pressure from 150 to 400 mbar, preferably 200 to 350 mbar. The mean pressure loss of the bag packaging is preferably less than 1 mbar for uncontaminated sealings and 3 to 15 mbar in the case of bags with a contaminated sealing seam.

The following measurement methods were used to characterise the raw materials and the films and the bags:

### Melt Flow Index

The melt flow index was measured in accordance with DIN EN ISO 1133-1.

### Water Vapour and Oxygen Permeability

The water vapour permeability was determined in accordance with DIN 53 122 Part 2. The oxygen barrier effect was determined in accordance with draft standard DIN 53 380 Part 3 at an air humidity of 50%.

### Determination of the Ethylene Content

The ethylene content of the polyolefin copolymers was determined by means of 13C-NMR spectroscopy. The measurements were taken using a nuclear magnetic resonance spectrometer from the company Bruker Avance 360. The copolymer to be characterised was dissolved in tetrachloroethane, such that a 10% mixture was produced. Octamethyltetrasiloxane (OTMS) was added as reference standard. The nuclear magnetic resonance spectrum was measured at 120° C. The spectra were evaluated as described in J. C. Randall Polymer Sequence Distribution (Academic Press, New York, 1977).

### Melting Point, Melting Range, Melt Enthalpy, Softening Point 11357-3

The above-specified parameters of the polyolefins were determined from a DSC curve of the respective polymer or of the respective polymer mixture. In the DSC measurement a quantity of heat per unit of time is fed to the polymer or the polymer mixture with a defined heating rate and the heat flow is plotted against the temperature, i.e. the change in the enthalpy is measured as deviating course of the heat flow from the base line. Below the base line (BL) is understood to be the (linear) part or start of the curve, in which no phase conversions occur and therefore no rise is recorded. Here, there is a linear relationship between the fed quantity of heat and the temperature. In the region in which melting processes occur, the heat flow increases by the necessary melt energy and the DSC curve rises and deviates from the base line. In the region in which most crystallites melt, the curve passes to a maximum and falls back to the base line once all crystallites have melted

The melting point in the sense of the present invention is the highest maximum of the second heating curve of the DSC measurement (point C or Y in FIG. 1). The start of the second heating curve in the sense of the present invention is the temperature at which the second heating curve deviates from the base line and the rise of the curve begins (point A or X in FIG. 1). Accordingly, the end is the temperature at which the curve has fallen again to the base line (point D or Z in FIG. 1). The softening point is the point at which the second heating curve reaches a first local maximum (point B in FIG. 1). This softening point does not occur in the case of the non-soft propylene homopolymers. The melting range is the distance between points B and C in the second heating curve.

The DSC measurement was performed using a sample from 2 to 6 mg in a differential calorimeter with a heating and cooling rate of 10K/1 min in a range from 20 to 200° C. A first DSC curve was first recorded, and the sample was then cooled. The second heating curve was then recorded under identical conditions and was evaluated as described above for the determination of the melting range, melting point and the softening point. The enthalpy was determined from the cooling curve (FIG. 2).

### Metal Adhesion

The surface-treated films were metallised 14 days after production thereof (short-term assessment) or 6 months after production thereof (long-term assessment). The metal adhesion was assessed by means of adhesive tape test. If no colour or no metal could be detached by means of adhesive tape, the adhesion was assessed to be very good, and with significant detachment of colour or metal the adhesion was assessed to be poor.

### Determination of the Seal Initiation Temperature

The HSG/ET sealing apparatus from Brugger was used to produce sealed samples (sealing seam 20 mm×100 mm) by sealing the cover layer I of the film against itself at different temperatures with the aid of two heated sealing jaws at a sealing pressure of 10 N/cm² and a sealing period of 0.5 s. Test strips of 15 mm width were cut from the sealed samples. The T-sealing seam strength, i.e. the force necessary to separate the test strips, was determined using a tensile testing machine at 200 mm/min removal rate, wherein the sealing seam plane forms a right angle with the tension direction. The seal initiation temperature SIT is the temperature at which a sealing seam strength of at least 0.5 N/15 mm is achieved.

### Maximum Sealing Seam Strength

The HSG/ET sealing apparatus from Brugger was used to produce sealed samples (sealing seam 20 mm×100 mm) by sealing the cover layer I of the film against itself at different temperatures with the aid of two heated sealing jaws at a temperature of 130° C. and at a sealing pressure of 10 N/cm² and a sealing period of 0.5 s. Test strips of 15 mm width were cut from the sealed samples. The T-sealing seam strength, i.e. the force necessary to separate the test strips, was determined using a tensile testing machine at 200 mm/min removal rate, wherein the sealing seam plane forms a right angle with the tension direction. The maximum sealing seam strength is the maximum of the curve recorded during this test.

### Light Permeability

The light permeability was measured in accordance with ASTM D 1003.

### Density

The density was determined in accordance with EN ISO 1183-1, method A.

### Surface Tension

The surface tension was determined by means of ink methods in accordance with DIN ISO 8296.

### Testing of the Bag Packaging

Production of the Four-Edge Bag without Contamination

Two film plies measuring 160×150 mm in size were cut out and placed one on top of the other via their sealing side (cover layer I). All four edges were sealed using a hot-sealing device from Brugger at a temperature of 140° C., a contact pressure of 52 N/cm² and a contact time of 2 s.

Production of the Four-Edge Bag with Dust Contamination in the Sealing Region

Two film plies measuring 160×150 mm in size were cut out and commercially available wheat flour was scattered on the sealing side (cover layer I). The excess wheat flour was blown off by means of compressed air. The sealing sides (cover layer I) contaminated in this way with dusts were placed one on top of the other. All four edges were sealed using a hot-sealing device from Brugger at a temperature of 140° C., a contact pressure of 52 N/cm² and a contact time of 2 s.

### Bursting and Tightness Tests

The bursting and tightness tests of the bags were carried out by means of the methods described hereinafter. Each bag to be tested was pierced centrally using the test head of the Skye tester (for example Skye 2500SL from Mocon). An expansion limiter set to a height of 20 mm prevented a bag from being able to be inflated excessively in a balloon-like manner.

### Burst Test

Each of the bags to be tested was inflated on the Skye tester with a pressure rise of 10 mbar/s until bursting. The highest internal pressure reached by a bag was noted as bursting pressure (maximum overpressure). This test was carried out on at least 10 bags.

### Tightness Test

The bag was inflated to a preliminary pressure of approximately 50-60% of the determined bursting pressure from the previous burst test. After reaching this preliminary pressure, the pressure loss was measured over a period of 30 s and recorded. This test was carried out on at least 10 bags. In some comparative examples the bags failed in this tightness test. This means that there was no longer any overpressure already before 30 s had passed and the Skye tester switched off automatically.

The invention will now be explained by the following examples.

### EXAMPLE 1

A five-layer precursor film was extruded according to the coextrusion method from a flat film die at an extrusion temperature from 240 to 270° C. This precursor film was first drawn off on a cooling roll and cooled. Subsequently, the precursor film was oriented in the longitudinal and transverse directions and finally fixed. The surface of the second cover layer II was pre-treated using corona to elevate the surface tension. The five-layer film had a layer structure of first cover layer I/first intermediate layer I/base layer/second intermediate layer II/second cover layer II II. The individual layers of the film had the following composition:

### First Cover Layer I (1.5 μm):

approximately 30% by weight propylene-butylene copolymer with a butylene proportion of 25% by weight (in relation to the copolymer) and a melting point of 75° C.;
and a melt flow index of 7.0 g/10 min at 230° C. and 2.16 kg load approximately 60% by weight ethylene-propylene-butylene terpolymer with a melting point of 135° C. and a melt flow index of 5.5 g/10 min at 230° C. and 2.16 kg load
0.13% by weight polymethyl methacrylate (PMMA)

### First Intermediate Layer I (4 μm):

approximately 50% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load and
approximately 50% by weight ethylene-propylene-butylene terpolymer having a melting point of 135° C. and a softening point of 103° C. and a melt flow index of 5.5 g/10 min at 230° C. and 2.16 kg load

### Base Layer:

Approximately 100% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load

### Second Cover Layer II (1.0 μm):

99.7% by weight propylene-butylene copolymer having a butylene proportion of 5% by weight (in relation to the copolymer) and a melting point of 140° C.; and a melt flow index of 5.5 g/10 min at 230° C. and 2.16 kg load
0.3% by weight anti-blocking agent with a mean particle diameter of approximately 4 μm (Sylobloc 45)

All layers of the film additionally contained stabiliser and neutralisation agent in conventional quantities.

The following specific conditions and temperatures were selected when producing the film:

extrusion: extrusion temperature approximately 250-270° C.
chill roll: temperature 30° C.,
longitudinal stretching: T=125° C.
longitudinal stretching by the factor of 5
transverse stretching: T=165° C.
transverse stretching by the factor of 9
fixing T=143° C.

The film was surface-treated by corona on the surface of the second cover layer II and exhibited a surface tension of 40 mN/m on this side. The film had a thickness of 30 μm and a transparent appearance.

### EXAMPLE 2

A film was produced according to Example 1. In contrast to Example 1, a second intermediate layer having the following composition was inserted:

### Second Intermediate Layer II (1.5 μm):

approximately 100% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load

### EXAMPLE 3

A film was produced according to Example 1. In contrast to Example 1, the composition of the first intermediate layer I was changed. The first intermediate layer I now had the following composition:

### First Intermediate Layer I (4 μm):

approximately 50% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load and
approximately 50% by weight propylene-butylene copolymer having a butylene proportion of 25% by weight (in relation to the copolymer) and a melting point of 75° C.; and a softening point of a melt flow index of 7.0 g/10 min at 230° C. and 2.16 kg load

### EXAMPLE 4

A film was produced according to Example 2. In contrast to Example 2, TiO₂ particles were added to the base layer. The base layer now had the following composition:

approximately 97% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load
3.0% by weight TiO₂ via master batch P87286, supplied by Schulman GmbH, Hüttenstraβe 211, D-54578 Kerpen.

### EXAMPLE 5

A film was produced according to Example 1. In contrast to Example 1, the composition of the intermediate layer I was changed as follows:

approximately 70% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load (DIN 53 735) and
approximately 30% by weight polyethylene (MDPE; density 0.924 g/cm³) having a melting point of 125° C. and a softening point of 114° C. and a melt flow index of 0.15 g/10 min at 190° C. and 2.16 kg load

### COMPARATIVE EXAMPLE 1

A film was produced according to Example 1. In contrast to Example 1, CaCO₃ and TiO₂ were added to the base layer. The base layer now had the following composition: approximately 93% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load
4.0% by weight CaCO₃ of type ®Omyalite 901, master batch supplier Multibase, Z.I. du Giers, F-38380 Saint-Laurent-du-Pont, France;
3.0% by weight TiO₂ via master batch P87286, supplier Schulman GmbH, Hüttenstraβe 211, D-54578 Kerpen.

The film now had a white opaque appearance and, on account of vacuole formation in the base layer, a reduced density of 0.75 g/cm³.

### COMPARATIVE EXAMPLE 2

A film was produced according to Example 1. In contrast to Example 1 the soft first intermediate layer I was omitted such that only a three-layer film constituted of base layer and first and second cover layer, was produced.

### COMPARATIVE EXAMPLE 3

A film was produced according to CE2. In contrast to CE1, the following mixture was used for the cover layer I:

approximately 50% by weight propylene-butylene copolymer having a butylene proportion of 25% by weight (in relation to the copolymer) and a melting point of 75° C.; and a melt flow index of 7.0 g/10 min at 230° C. and 2.16 kg load
approximately 50% by weight ethylene-propylene-butylene terpolymer having a melting point of 135° C. and a melt flow index of 5.5 g/10 min at 230° C. and 2.16 kg load
0.13% by weight polymethyl methacrylate (PMMA)

### COMPARATIVE EXAMPLE 4

A film was produced according to Example 1. In contrast to Example 1, CaCO₃ and TiO₂ were added to the intermediate layer II. The intermediate layer now had the following composition:

approximately 93% by weight propylene homopolymer (PP) having an n-heptane-soluble proportion of approximately 4% by weight (in relation to 100% PP) and a melting point of 163° C.; and a melt flow index of 3.3 g/10 min at 230° C. and 2.16 kg load (DIN 53 735)
4.0% by weight CaCO₃ of type ®Omyalite 90T, master batch supplier Multibase, Z.I. du Giers, F-38380 Saint-Laurent-du-Pont, France;
3.0% by weight TiO₂ via master batch P87286, supplier Schulman GmbH, Hüttenstraβe 211, D-54578 Kerpen.

The film now had a white opaque appearance and, on account of vacuole formation in the intermediate layer, a reduced density of 0.90 g/cm³.

All films according to the examples and the comparative examples were coated on the surface of the first cover layer I with an aluminium layer in a vacuum metallisation installation. In order to improve the metal adhesion, the surface was subjected to a plasma treatment immediately before the coating. Four-edge bag packaging was produced from the metallised films as described in the test methods “Testing of the bag packaging”. The properties of the metallised films according to the examples and the comparative examples and the properties of the bag packaging produced therefrom are summarised in Table 1. It can be seen that the films according to the invention according to Examples 1, 2 and 3 have excellent barrier values against water vapour and oxygen and at the same time good sealing properties in spite of contamination when used as bag packaging for powdery filling materials. The bag packaging has considerably improved bursting capability and fewer pressure losses.

| | | | Max. sealing | | | | | | |
|---|---|---|---|---|---|---|---|---|---|
| | | | seam strength ** | Bursting | | Bursting pressure | Mean | | OTR 23° C., |
| | | | at 130° C., | pressure | Mean | (max. overpressure) | pressure | WVP 38° C. | 50% rel. |
| | Thick- | Density of | 10 N/cM², | (max. over- | pressure | Contaminated | loss [mbar] | 90% rel. | humidity *** |
| Exam- | ness | the film | 0.5 sec. | pressure) | loss | sealing area | Contaminated | humidity *** | [cm³/m²* |
| ple | μm | [g/cm³] | [N/15 mm] | [mbar] | [mbar] | [mbar] | sealing area | [g/m²*day] | day*bar] |
| Ex. 1 | 30 | 0.91 | 7.9 | 561-631 | 0.8 | 187-296 | 10.6 | 0.125 | 17.8 |
| Ex. 2 | 30 | 0.91 | 7.8 | 572-617 | 0.5 | 200-291 | 9.8 | 0.140 | 21.4 |
| Ex. 3 | 30 | 0.91 | 8.7 | 601-720 | 0.3 | 273-386 | 5.5 | 0.155 | 27.0 |
| Ex. 4 | 30 | 0.92 | 7.6 | 533-611 | 0.9 | 177-285 | 13.2 | 0.173 | 30.1 |
| Ex. 5 | 30 | 0.91 | 7.2 | 492-573 | 1.4 | 153-285 | 11.1 | 0.162 | 25.4 |
| CE 1 | 30 | 0.75 | 2.9 | 112-264 | 4.0 | 82-154 | 23.7 **** | 0.254 | 89.3 |
| CE 2 | 30 | 0.91 | 5.0 | 214-243 | 1.7 | 108-151 | 51.1 ***** | 0.168 | 34.2 |
| CE 3 | 30 | 0.91 | 4.6 | 220-289 | 1.4 | 123-148 | 43.4 ****** | 0.181 | 31.5 |
| CE 4 | 30 | 0.90 | 2.7 | 131-211 | 2.1 | 98-139 | 44.1 ******* | 0.225 | 40.4 |

** sealing of the non-metallised cover layer I against itself
*** after metallisation of the cover layer II
**** only one bag in 10 passes the test
***** 6 bags in 10 fail during the test
****** 4 bags in 10 fail during the test
******* only 1 bag in 10 passes the test

1.-22. (canceled)

23. A biaxially oriented, multilayer polypropylene film having at least three layers constituted of a base layer and a first intermediate layer I and a first sealable cover layer I applied to this intermediate layer I, wherein the first intermediate layer I is a soft intermediate layer and all layers of the film substantially do not contain vacuoles.

24. The film according to claim 23, wherein the density of the film is at most 5% lower than the mathematical density of the film.

25. The film according to claim 23, wherein the film is transparent and has a density in the range from 0.86 to 0.92 g/cm³.

26. The film according to claim 23, wherein the film contains pigments and the density of the film lies in a range from 0.91 to 0.95 g/cm³.

27. The film according to claim 23, wherein the first soft intermediate layer I contains at least one soft polymer or is constructed from a polymer mixture containing soft polymer, wherein the second heating curve of this polymer or the mixture in a DSC measurement starts to rise in a temperature range from 20 to 70° C., such that the second heating curve deviates from the base line.

28. The film according to claim 23, wherein the first soft intermediate layer I contains at least one soft polymer or is constructed from a polymer mixture containing soft polymer, wherein the second heating curve of this polymer or of the mixture in a DSC measurement has a softening point (B).

29. The film according to claim 28, wherein the softening point (B) lies in a range from 80 to 120° C.

30. The film according to claim 23, wherein the first soft intermediate layer I contains at least one soft polymer or is constructed from a polymer mixture containing soft polymer, wherein the melting point (C) of the soft polymer or of the polymer mixture lies in a range from 70 to ≦150° C.

31. The film according to claim 23, wherein the first soft intermediate layer I contains at least one soft polymer or is constructed from a polymer mixture containing soft polymer, wherein the melting point (C) of the soft polymer or of the mixture lies in a range from 70 to ≦150° C. and is at least 60° C. higher than the softening point (B).

32. The film according to claim 23, wherein the base layer of the film is constructed from non-soft polyolefins or a mixture, wherein
(a) the second heating curve of this non-soft polymer or mixture in a DSC measurement starts to rise in a temperature range from 110 to 140° C., such that the second heating curve deviates from the base line and/or
(b) the second heating curve of this non-soft polymer or mixture in a DSC measurement does not have a softening point (B)
(c) the melting point (C) of the soft polymer or mixture of the intermediate layer I is 15 to 60° C. less than the melting point (Y) of the non-soft polyolefin or of the non-soft mixture of the base layer.

33. The film according to claim 23, wherein the soft polymer of the intermediate layer is a polyethylene, a propylene copolymer, a propylene terpolymer, an elastomer, a heterophase mixed polymer and/or a propylene homopolymer with <95% isotacticity.

34. The film according to claim 23, wherein the sealable cover layer I has a seal initiation temperature of <115° C.

35. The film according to claim 34, wherein the film is not pre-treated on the surface of the first cover layer by means of corona, plasma or flame.

36. The film according to claim 23, wherein the film on the opposite side has a second cover layer II and the surface of the second cover layer II is metallized.

37. The film according to claim 36, wherein the surface to be metallized is treated by means of plasma immediately before the metallization, and the optical density of the metal layer is at least 2.5.

38. A process for producing a laminate comprising utilizing the film according to claim 23 and a further biaxially oriented polypropylene film, wherein the metallized film is laminated with the metallized side against a second boPP film.

39. The process according to claim 38, wherein the second boPP film of the laminate has a vacuole-containing base layer.

40. A bag packaging comprising the film according to claim 23, wherein the bag packaging has a bursting pressure of at least 200 mbar.

41. A bag packaging comprising the film according to claim 23, wherein the bag packaging has a mean pressure loss of less than 15 mbar.

42. The film according to claim 23, wherein the first sealable cover layer I is sealed against itself at a temperature of 130° C. with a pressure of 10 N for 0.5 s and this sealing seam has a maximum sealing seam strength of more than 6 N/15 mm.
